(19) United States
(12) Patent Application Publication
(10) Pub. No.: US 2021/0304031 A1
(43) Pub. Date: Sep. 30, 2021

(54) LEARNING DEVICE AND NON-TRANSITORY COMPUTER READABLE MEDIUM

(71) Applicant: FUJIFILM Business Innovation Corp., Tokyo (JP)

(72) Inventors: Shintaro ADACHI, Kanagawa (JP); Akinobu YAMAGUCHI, Kanagawa (JP); Kunikazu UENO, Kanagawa (JP); Yang LIU, Kanagawa (JP)

(73) Assignee: FUJIFILM Business Innovation Corp., Tokyo (JP)

(21) Appl. No.: 17/016,364

(22) Filed: Sep. 9, 2020

(30) Foreign Application Priority Data
Mar. 27, 2020 (JP) 2020-058590

(51) Int. Cl. G06N 5/04; G06N 20/00

(52) U.S. Cl. CPC G06N 5/04; G06N 20/00

(57) ABSTRACT

A learning device includes a processor configured to select a trained data set from multiple trained data sets that are respectively used for machine learning for multiple past cases. The multiple trained data sets each includes input data, correct data, and a trained model. The selected trained data set is similar to a learning data set including input data and correct data to be used for machine learning for a new case. The processor is also configured to perform machine learning by using the input data and the correct data of the selected trained data set and the input data and the correct data of the learning data set.

### CROSS-REFERENCE TO RELATED APPLICATIONS

This application is based on and claims priority under 35 USC 119 from Japanese Patent Application No. 2020-058590 filed Mar. 27, 2020.

### BACKGROUND

### (i) Technical Field

The present disclosure relates to a learning device and a non-transitory computer readable medium.

### (ii) Related Art

For example, Japanese Unexamined Patent Application Publication No. 10-283458 describes an image processing apparatus that performs image processing on input image data in accordance with the feature of the image data and outputs processed image data. The image processing apparatus includes an image processing unit, a designation unit, a neural network, and a learning unit. The image processing unit has multiple types of image processing components for respective different types of image processing. The designation unit designates at least one image processing component to be used among the image processing components in the image processing unit or designates the number of image processing components to be used. In the neural network, data representing the feature of image data is input to an input layer, and selection data for selecting one of the image processing components designated by the designation unit is output from an output layer. The learning unit is provided to train the neural network to output, from the output layer, selection data for selecting an appropriate image processing component corresponding to data input to the input layer.

Japanese Unexamined Patent Application Publication No. 2016-004548 describes a providing device that enables a deep neural network (DNN) to be used easily. The providing device includes a registration unit and a receiving unit. The registration unit registers learning devices in which nodes to output results of calculation on input data are connected and that each extract a feature corresponding to a predetermined type from the input data. The receiving unit receives the designation of the type of a feature. The providing device further includes a providing unit and a calculation unit. On the basis of the learning devices registered by the registration unit, the providing unit selects a learning device that extracts a feature corresponding to the type of the feature received by the receiving unit. The providing unit provides a new learning device generated on the basis of the selected learning device. The calculation unit calculates a price to be paid to a seller that provides the learning device selected by the providing unit.

### SUMMARY

When machine learning is performed by using the learning data set of a new case, the performance, the quality, and the like of the learning model of the new case is guaranteed by effectively using trained data sets resulting from machine learning performed on past cases.

However, it is not necessarily useful to make use of all of multiple trained data sets used in multiple past cases, and excluding a trained data set dissimilar to the learning data set of the new case and selectively making use of only a similar trained data set is more desirable than making use of all the trained data sets.

Aspects of non-limiting embodiments of the present disclosure relate to a learning device and a non-transitory computer readable medium that are enabled to perform machine learning in such a manner that a trained data set similar to a learning data set of a new case is selectively used among multiple trained data sets used for multiple past cases.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a learning device including a processor configured to select a trained data set from multiple trained data sets that are respectively used for machine learning for multiple past cases. The multiple trained data sets each includes input data, correct data, and a trained model. The selected trained data set is similar to a learning data set including input data and correct data to be used for machine learning for a new case. The processor is also configured to perform machine learning by using the input data and the correct data of the selected trained data set and the input data and the correct data of the learning data set.

### BRIEF DESCRIPTION OF THE DRAWINGS

Exemplary embodiments of the present disclosure will be described in detail based on the following figures, wherein:

FIG. 1 is a block diagram illustrating an example electrical configuration of a learning device according to a first exemplary embodiment;

FIG. 2 is a block diagram illustrating an example functional configuration of the learning device according to the first exemplary embodiment;

FIG. 3 is a conceptual diagram illustrating an example of a neural network according to the first exemplary embodiment.

FIG. 4 is a diagram for explaining a degree-of-similarity calculation method according to the first exemplary embodiment;

FIG. 5 is a flowchart illustrating an example of the flow of processing performed by a learning program according to the first exemplary embodiment;

FIG. 6 is a diagram for explaining data augmentation according to the first exemplary embodiment;

FIG. 7 is a diagram for explaining a degree-of-similarity calculation method according to a second exemplary embodiment;

FIG. 8 is a flowchart illustrating an example of the flow of processing performed by a learning program according to the second exemplary embodiment;

FIG. 9 is a diagram for explaining a degree-of-similarity calculation method according to a third exemplary embodiment;

FIG. 10 is a flowchart illustrating an example of the flow of processing performed by a learning program according to the third exemplary embodiment; and

FIG. 11 is a diagram illustrating an example of trained cases and a new case according to a fourth exemplary embodiment.

### DETAILED DESCRIPTION

Hereinafter, examples of exemplary embodiments for implementing the present disclosure will be described in detail with reference to the drawings.

### First Exemplary Embodiment

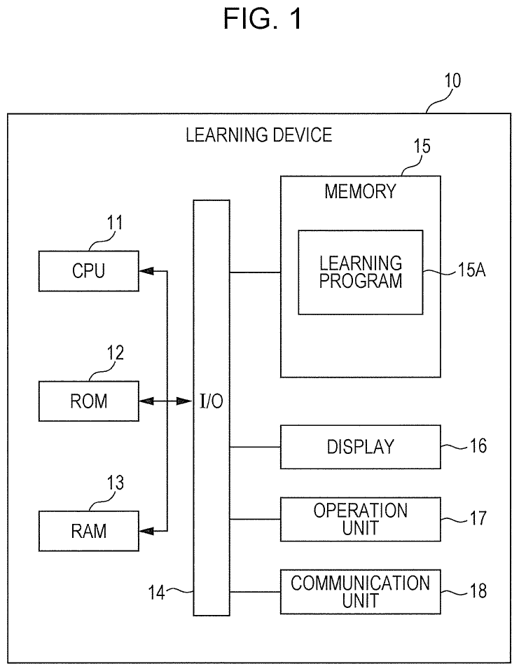

FIG. 1 is a block diagram illustrating an example electrical configuration of a learning device 10 according to a first exemplary embodiment.

As illustrated in FIG. 1, the learning device 10 according to this exemplary embodiment includes a central processing unit (CPU) 11, a read only memory (ROM) 12, a random access memory (RAM) 13, an input/output interface (I/O) 14, a memory 15, a display 16, an operation unit 17, and a communication unit 18. Instead of a CPU, the learning device 10 may include a graphics processing unit (GPU).

A general computer such as a server computer and a personal computer (PC) applies to the learning device 10 according to this exemplary embodiment. An image forming apparatus having multiple functions such as a copying function, a printing function, a faxing function, and a scanning function may apply to the learning device 10.

The CPU 11, the ROM 12, the RAM 13, and the I/O 14 are connected to each other via a bus. Functional units including the memory 15, the display 16, the operation unit 17, and the communication unit 18 are connected to the I/O 14. The functional units are able to mutually communicate with the CPU 11 via the I/O 14.

The CPU 11, the ROM 12, the RAM 13, and the I/O 14 constitute a controller. The controller may be configured as a sub-controller that controls part of the operation of the learning device 10 or may be configured as part of a main controller that controls overall operation of the learning device 10. For example, an integrated circuit (IC) using, for example, large scale integration (LSI) technology or an IC chipset is used for part or all of the blocks of the controller. Circuits may be used for the respective blocks, or a circuit having part or all of the blocks integrated thereinto may be used. The blocks may be integrated into one, or some blocks may be provided separately. In addition, part of each block may be provided separately. For the integration of the controller, not only the LSI technology but also a dedicated circuit or a general-purpose processor may be used.

As the memory 15, for example, a hard disk drive (HDD), a solid state drive (SSD), a flash memory, or the like is used. The memory 15 stores a learning program 15A according to this exemplary embodiment. The learning program 15A may be stored in the ROM 12.

The learning program 15A may be installed in advance, for example, on the learning device 10. The learning program 15A may be implemented in such a manner as to be stored in a nonvolatile storage medium or distributed through a network and then to be installed appropriately on the learning device 10. As an example of the nonvolatile storage medium, a compact disc read only memory (CD-ROM), a magneto-optical disk, a HDD, a digital versatile disc read only memory (DVD-ROM), a flash memory, a memory card, or the like is conceivable.

As the display 16, for example, a liquid crystal display (LCD), an organic electro luminescence (EL) display, or the like is used. The display 16 may have a touch panel integrated thereinto. The operation unit 17 is provided with a device for an input operation such as a keyboard or a mouse. The display 16 and the operation unit 17 receive various designations from a user of the learning device 10. The display 16 displays the result of a process executed in accordance with the designation received from the user and various pieces of information such as a notification of the process.

The communication unit 18 is connected to a network such as the Internet, a LAN, or a wide area network (WAN) and is able to communicate with other external apparatuses via the network.

As described above, in performing machine learning on a new case to generate a learning model, it is not necessarily useful to make use of all of multiple trained data sets used in multiple past cases, and excluding a trained data set dissimilar to the learning data set of the new case and selectively making use of only a similar trained data set is more desirable than making use of all the trained data sets.

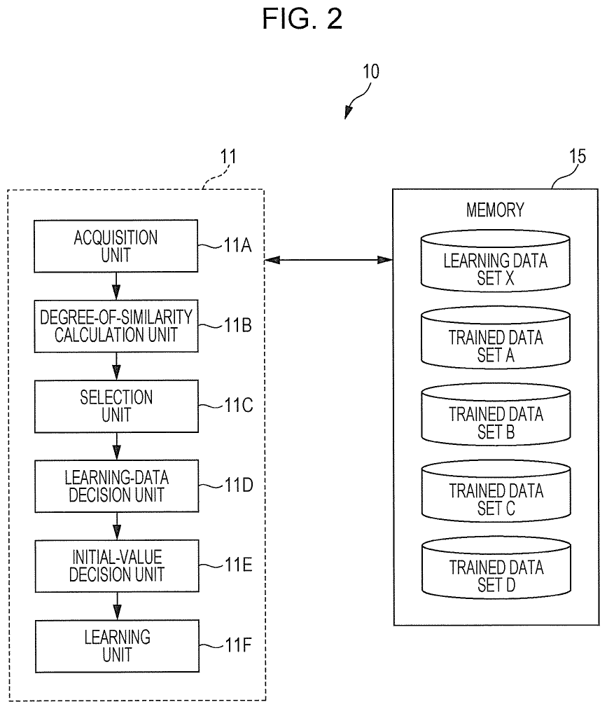

Accordingly, the CPU 11 of the learning device 10 according to this exemplary embodiment runs the learning program 15A stored in the memory 15 after loading the learning program 15A on the RAM 13 and thereby functions as the units illustrated in FIG. 2. The CPU 11 is an example of a processor.

FIG. 2 is a block diagram illustrating an example functional configuration of the learning device 10 according to the first exemplary embodiment.

As illustrated in FIG. 2, the CPU 11 of the learning device 10 according to this exemplary embodiment functions as an acquisition unit 11A, a degree-of-similarity calculation unit 11B, a selection unit 11C, a learning-data decision unit 11D, an initial-value decision unit 11E, and a learning unit 11F.

The memory 15 according to this exemplary embodiment stores a learning data set X to be used for machine learning for a new case (hereinafter, referred to as New Case X). The learning data set X includes input data and correct data. The learning data set X may further include data regarding a difference between the input data and the correct data. The input data and the correct data is, for example, image data. The image data may include a character string or the like.

The memory 15 also stores multiple trained data sets A, B, C, and D used for machine learning for multiple past cases (hereinafter, referred to as Case A, Case B, Case C, and Case D). It suffices that the number of past cases may be 2 or more and is not limited to 4. The trained data set A includes input data, correct data, and a trained model. The trained model is a trained model for Case A obtained by performing machine learning using the input data and the correct data. The trained data set A may further include data regarding a difference between the input data and the correct data. The input data and the correct data is, for example, image data. The image data may include a character string or the like. The other trained data sets B, C, and D also have the same configuration as that of the trained data set A. The learning data set X and the trained data sets A to D may be stored in an external memory device accessible from the learning device 10.

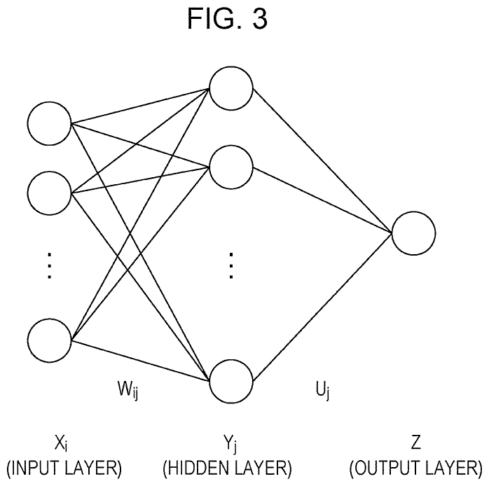

For example, a neural network (NN) and a convolutional neural network (CNN) apply to the learning model generated by machine learning. An overview of a neural network according to this exemplary embodiment will be described with reference to FIG. 3.

FIG. 3 is a conceptual diagram illustrating an example of the neural network according to this exemplary embodiment.

The neural network illustrated in FIG. 3 has an input layer xᵢ, a hidden layer (also referred to as an intermediate layer) yⱼ, and an output layer z.

The neural network illustrated in FIG. 3 has the simplest three-layer configuration for simplified explanation but may have a multilayer configuration having two or more hidden layers yⱼ. The output layer z has one node (also referred to as a neuron) but may have multiple nodes.

Output in response to input to the neural network is calculated in order from the input by using Formula (1) below. Note that f(•) is called an activation function, and, for example, the sigmoid function is used. In addition, xᵢ is input to the input layer xᵢ; yⱼ, output from the hidden layer yⱼ; z, output from the output layer z; and wᵢⱼ and uⱼ, weighting coefficients. Changing the weighting coefficients wᵢⱼ and uⱼ leads to different output in response to the same input. Specifically, to obtain desired output, the weighting coefficients wᵢⱼ and uⱼ are updated, and the models are trained.

$${y}_{j} = f ( {\sum }_{i} {w}_{ij} {x}_{i} ) \\ z = f ( {\sum }_{j} {u}_{j} {y}_{j} ) \qquad ( 1 )$$

The CPU 11 according to this exemplary embodiment selects a trained data set similar to the learning data set X to be used for the machine learning for New Case X from among the multiple trained data sets A to D. The CPU 11 performs the machine learning by using the input data and the correct data of the selected trained data set and the input data and the correct data of the learning data set X.

More specifically, the acquisition unit 11A according to this exemplary embodiment acquires the learning data set X and the multiple trained data sets A to D from the memory 15.

The degree-of-similarity calculation unit 11B according to this exemplary embodiment calculates the degree of similarity of the learning data set X acquired by the acquisition unit 11A to each of the multiple trained data sets A to D. Specifically, the degree of similarity between the learning data set X and the trained data set A, the degree of similarity between the learning data set X and the trained data set B, the degree of similarity between the learning data set X and the trained data set C, and the degree of similarity between the learning data set X and the trained data set D are calculated. For example, a mean square error is used as an index for the degrees of similarity. A smaller mean square error leads to a determination of a higher degree of similarity. A specific degree-of-similarity calculation method will be described later.

The selection unit 11C according to this exemplary embodiment selects the trained data set similar to the learning data set X from among the multiple trained data sets A to D on the basis of the degrees of similarity calculated by the degree-of-similarity calculation unit 11B. For example, the selection unit 11C may select the trained data set having the highest degree of similarity of the multiple trained data sets A to D or may select N (<4) trained data sets in order from the highest degree of similarity of the multiple trained data sets A to D.

The learning-data decision unit 11D according to this exemplary embodiment decides learning data to be used for the machine learning for New Case X. Specifically, the learning-data decision unit 11D decides the trained data set selected by the selection unit 11C and the learning data set X of New Case X as learning data.

The initial-value decision unit 11E according to this exemplary embodiment decides an initial value to be used for the machine learning for New Case X. For example, the initial-value decision unit 11E decides, as the initial value for the machine learning, a value obtained from the trained data set selected by the selection unit 11C. At this time, a value obtained from the trained data set selected by the selection unit 11C may also apply to a hyper parameter.

The learning unit 11F according to this exemplary embodiment performs the machine learning for New Case X by using the learning data decided by the learning-data decision unit 11D and the initial value decided by the initial-value decision unit 11E and generates a learning model.

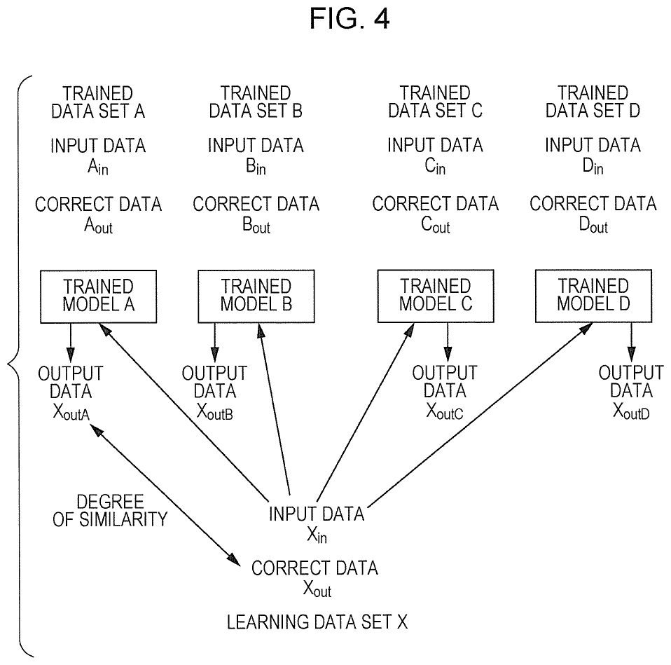

A degree-of-similarity calculation method according to the first exemplary embodiment will be described specifically with reference to FIG. 4.

FIG. 4 is a diagram for explaining the degree-of-similarity calculation method according to the first exemplary embodiment.

As illustrated in FIG. 4, the learning data set X includes input data Xᵢₙ and correct data Xₒᵤₜ. The trained data set A includes input data Aᵢₙ, correct data Aₒᵤₜ, and a trained model A. Likewise, the trained data set B includes input data Bᵢₙ, correct data Bₒᵤₜ, and a trained model B. The trained data set C includes input data Cᵢₙ, correct data Cₒᵤₜ, and a trained model C. The trained data set D includes input data Dᵢₙ, correct data Dₒᵤₜ, and a trained model D.

The degree-of-similarity calculation unit 11B inputs the input data Xᵢₙ of the learning data set X to the trained models A to D of the respective trained data sets A to D and calculates the degree of similarity between each of pieces of output data X_{outA}, X_{outB}, X_{outC}, and X_{outD} respectively obtained from the trained models A to D and the correct data Xₒᵤₜ of the learning data set X. The selection unit 11C selects a trained data set similar to the learning data set X on the basis of the degrees of similarity calculated by the degree-of-similarity calculation unit 11B. For example, if the data is image data, each degree of similarity is represented by, for example, at least one of a difference between the pixel value of the output data and the pixel value of the correct data, the recognition rate of the output data to the correct data, and an edit distance from the output data to the correct data.

The degree of similarity is decided on the basis of, for example, the pixel value of the output data and the pixel value of the correct data. Specifically, it may be said that selecting a data set having a slight difference between the pixel value of the output data and the pixel value of the correct data corresponds to selecting a data set having a higher degree of similarity between the images itself. It may also be said that selecting a data set having a close recognition rate to the correct data corresponds to selecting an image having a close recognition result in a recognition process in a later stage.

For example, if a pixel value difference between images is used, a smaller pixel value difference leads to a higher degree of similarity between the images. In this case, it suffices that a pixel value difference between corresponding pixels or corresponding regions in the respective images is obtained. In the case of the corresponding regions, it suffices that a difference of one of mean values, the maximum values, and the minimum values of pixel values of respective pixels in the region is obtained.

If the recognition rate of the images is used, a higher recognition rate corresponds to a higher degree of similarity between the images. The recognition rate is calculated, for example, by a character recognition engine that performs character recognition or an image recognition engine that performs image recognition.

The edit distance is also called the Levenshtein distance and is a type of distance indicating how different two character strings are. Specifically, the edit distance is defined as the minimum number of times one of the character strings is deformed to the other character string by inserting, deleting, replacing a character. If the edit distance between images is used, a smaller number of times as the edit distance leads to a higher degree of similarity between the images. Like the recognition rate, the edit distance is calculated by the aforementioned character recognition engine. Specifically, for using the recognition rate or the edit distance, the learning device 10 includes the character recognition engine or the image recognition engine.

If the learning data set X has multiple pieces of input data Xᵢₙ, the degree of similarity between the output data X_{outA} of the trained data set A and the correct data Xₒᵤₜ is calculated for each piece of input data Xᵢₙ. Accordingly, multiple degrees of similarity are calculated for the trained data set A. In this case, for example, one of the mean value, the maximum value, and the minimum value of the multiple degrees of similarity may be used for the degree of similarity to the trained data set A, or the count of degrees of similarity exceeding a threshold among the multiple degrees of similarity may be used for the degree of similarity to the trained data set A. The degree of similarity is likewise calculated for the other trained data sets B to D. In this case, the selection unit 11C selects a trained data set similar to the learning data set X on the basis of the degree of similarity of each of the multiple trained data sets A to D calculated by the degree-of-similarity calculation unit 11B.

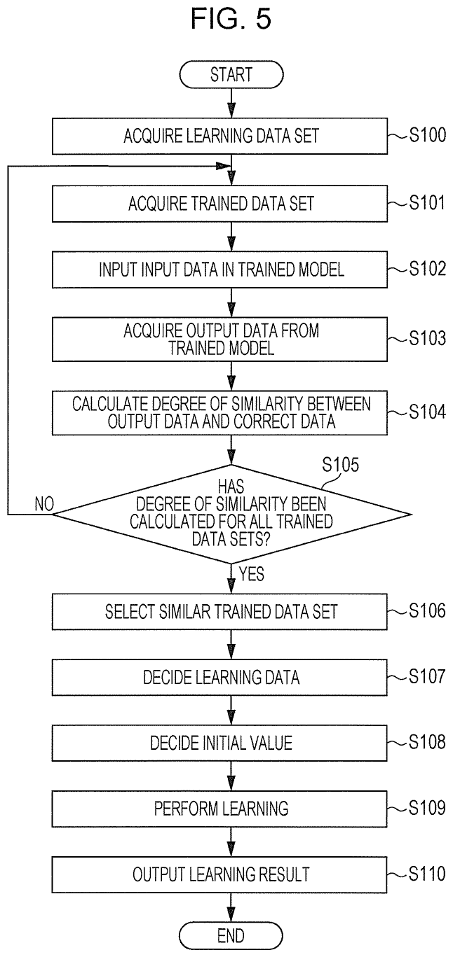

Actions of the learning device 10 according to the first exemplary embodiment will be described with reference to FIG. 5.

FIG. 5 is a flowchart illustrating an example of the flow of processing performed by the learning program 15A according to the first exemplary embodiment.

First, the learning device 10 is instructed to execute a machine learning process for New Case X, and then the CPU 11 starts the learning program 15A and performs the following steps.

In step S100 in FIG. 5, the CPU 11 acquires the learning data set X from the memory 15.

In step S101, the CPU 11 acquires a trained data set (for example, the trained data set A) stored in the memory 15 from among the multiple trained data sets A to D.

In step S102, the CPU 11 inputs, for example, the input data Xᵢₙ of the learning data set X to the trained model A, as illustrated in FIG. 4 above.

In step S103, the CPU 11 acquires, for example, the output data X_{outA} from the trained model A, as illustrated in FIG. 4 above.

In step S104, the CPU 11 calculates the degree of similarity between the output data X_{outA} acquired in step S103 and the correct data Xₒᵤₜ of the learning data set X. As described above, the degree of similarity is represented by at least one of, for example, the difference between the pixel value of the output data and the pixel value of the correct data, the recognition rate of the output data to the correct data, and the edit distance from the output data to the correct data.

In step S105, the CPU 11 determines whether the degree of similarity has been calculated for all the trained data sets. If it is determined that the degree of similarity has been calculated for all the trained data sets (an affirmative determination), the processing proceeds to step S106. If it is determined that the degree of similarity has not been calculated for all the trained data sets (a negative determination), the processing returns to step S101 and repeats the steps. In this exemplary embodiment, steps S101 to S104 are repeatedly performed for each of the trained data set B, the trained data set C, and the trained data set D. Specifically, the degree of similarity between the output data X_{outB} and the correct data Xₒᵤₜ is calculated for the trained data set B, the degree of similarity between the output data X_{outC} and the correct data Xₒᵤₜ is calculated for the trained data set C, and the degree of similarity between the output data X_{outD} and the correct data Xₒᵤₜ is calculated for the trained data set D.

To calculate each degree of similarity, the multiple trained data sets A to D may be narrowed down to one or more trained data sets processible by the learning device 10 on the basis of information regarding an implementation target for the learning device 10. The implementation target information is information regarding a target on which the learning device 10 is implemented. If the implementation target is, for example, an image forming apparatus, the throughput (performance such as a clock frequency or a memory space of the CPU or the GPU) of the image forming apparatus is not relatively high in many cases, and thus a trained data set having mass data is considered to be difficult to process. Accordingly, a trained data set having data with a certain amount or larger is desirably excluded from degree-of-similarity calculation targets. If the implementation target is, for example, an external cloud server or an internal on-premise server, whether to use a trained data set having data with the certain amount or larger as the degree of degree-of-similarity calculation target may be decided on the basis of the throughput (performance such as a clock frequency or a memory space of the CPU or the GPU) of the cloud server or the on-premise server.

In step S106, the CPU 11 selects a trained data set similar to the learning data set X from among the multiple trained data sets A to D having undergone the degree of similarity calculation by step S105. For example, if the mean value of the degrees of similarity is used for the degree of similarity, the trained data set having the highest mean value may be selected. Alternatively, if the count of degrees of similarity exceeding the threshold is used for the degree of similarity, the trained data set having the highest count may be selected.

In step S107, the CPU 11 decides learning data to be used for the machine learning for New Case X. Specifically, the trained data set selected in step S106 and the learning data set X of New Case X are decided as the learning data. In deciding the learning data, processing called data augmentation in which the number of pieces of data is increased may be performed.

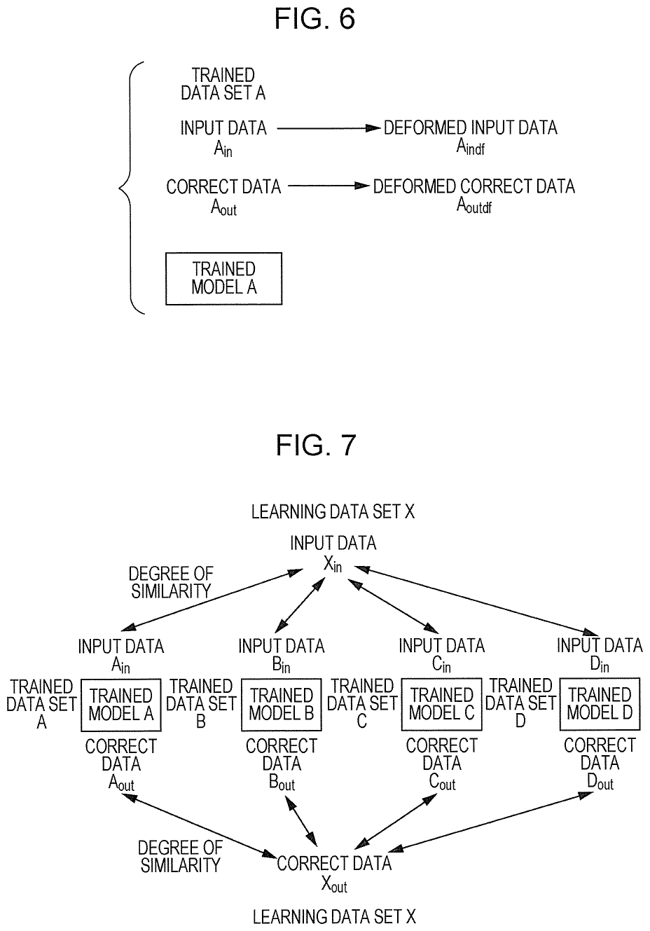

FIG. 6 is a diagram for explaining the data augmentation according to this exemplary embodiment.

On the assumption that the trained data set selected above is, for example, the trained data set A as illustrated in FIG. 6, the trained data set A further includes deformed input data A_{indf} and deformed correct data A_{outdf}. The deformed input data A_{indf} is obtained by deforming the input data Aᵢₙ. The deformed correct data A_{outdf} is the correct data of the deformed input data A_{indf}. Deforming herein denotes, for example, inversing, enlarging, or reducing. In this case, the machine learning is performed by using the input data Aᵢₙ, the correct data Aₒᵤₜ, the deformed input data A_{indf}, and the deformed correct data A_{outdf} of the selected trained data set A and the input data Xᵢₙ and the correct data Xₒᵤₜ of the learning data set X.

In step S108, the CPU 11 decides an initial value to be used for the machine learning for New Case X. As described above, for example, a value obtained from the trained data set selected in step S106 is decided as the initial value for the machine learning. At this time, a value obtained from the trained data set selected in step S106 may apply to the hyper parameter.

In step S109, the CPU 11 performs the machine learning for New Case X by using the learning data decided in step S107 and the initial value decided in step S108 and generates a learning model.

In step S110, the CPU 11 outputs the learning model generated in step S109 as a learning result and then terminates the series of steps performed by the learning program 15A.

According to this exemplary embodiment as described above, the machine learning is used by selectively using the trained data set similar to the learning data set of the new case among the multiple trained data sets used for the multiple respective past cases. This enables efficient and accurate machine learning.

The degree of similarity is calculated by using the trained model of the trained data set. The degree of similarity between the learning data set of the new case and the trained data set is thus calculated efficiently and accurately.

### Second Exemplary Embodiment

In the description for the first exemplary embodiment above, the degree of similarity is calculated by using the trained model of the trained data set. In a second exemplary embodiment, calculating the degree of similarity by using corresponding pieces of data of the trained data sets will be described.

This exemplary embodiment has the same configuration as that of the learning device 10 described for the first exemplary embodiment above. Repeated explanation is omitted, and only a difference will be described with reference to FIG. 2 above.

FIG. 7 is a diagram for explaining a degree-of-similarity calculation method according to the second exemplary embodiment.

As illustrated in FIG. 7, the learning data set X incudes the input data Xᵢₙ and the correct data Xₒᵤₜ. The trained data set A includes the input data Aᵢₙ, the correct data Aₒᵤₜ, and the trained model A. Likewise, the trained data set B includes the input data Bᵢₙ, the correct data Bₒᵤₜ, and the trained model B. The trained data set C includes the input data Cᵢₙ, the correct data Cₒᵤₜ, and the trained model C. The trained data set D includes the input data Dᵢₙ the correct data Dₒᵤₜ, and the trained model D.

The degree-of-similarity calculation unit 11B calculates the degree of similarity to the learning data set X for each of the multiple trained data sets A to D. The selection unit 11C selects a trained data set similar to the learning data set X on the basis of the degree of similarity calculated by the degree-of-similarity calculation unit 11B. For example, if the data is image data, the degree of similarity is represented by, for example, at least one of the degree of similarity between each of the pieces of input data Aᵢₙ to Dᵢₙ of the respective trained data sets A to D and the input data Xᵢₙ of the learning data set X and the degree of similarity between each of the pieces of correct data Aₒᵤₜ to Dₒᵤₜ of the respective trained data sets A to D and the correct data Xₒᵤₜ of the learning data set X. In this case, each degree of similarity may be calculated from, for example, the attribute information of the image data, a recognition target, or the like. The attribute information includes information regarding color/black and white, an image size, a feature, an amount of handwritten characters, an amount of typeset characters, a difference between input data and correct data, and the like. The recognition target includes a QR code (registered trademark), a typeset character, a handwritten character, a barcode, and the like.

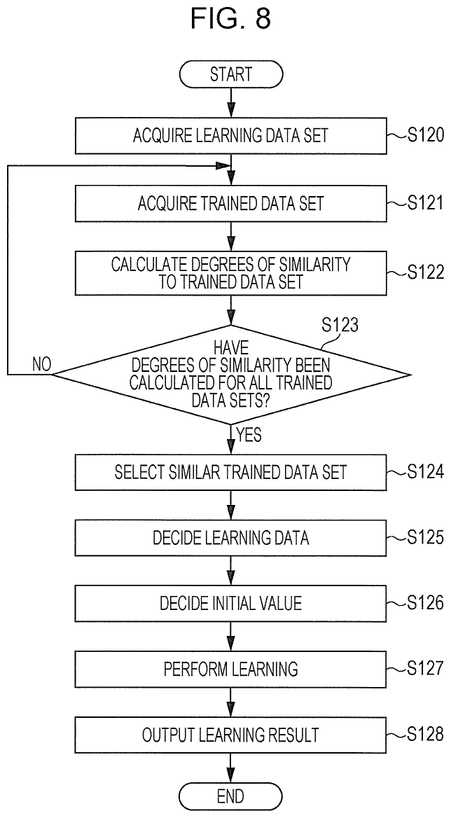

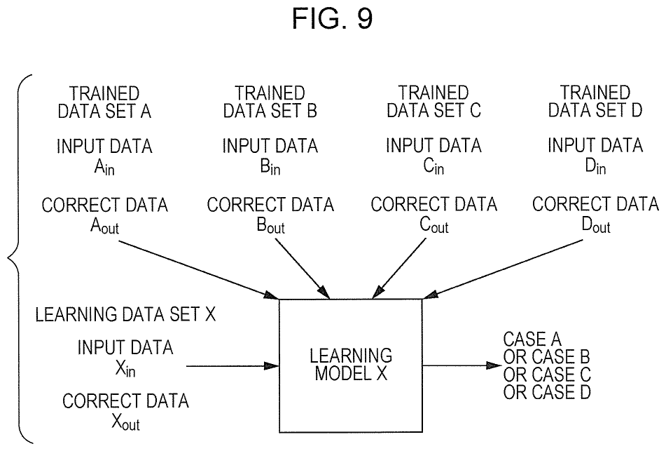

Actions of the learning device 10 according to the second exemplary embodiment will be described with reference to FIG. 8.

FIG. 8 is a flowchart illustrating an example of the flow of processing performed by a learning program 15A according to the second exemplary embodiment.

First, the learning device 10 is instructed to execute a machine learning process for New Case X, and then the CPU 11 starts the learning program 15A and performs the following steps.

In step S120 in FIG. 8, the CPU 11 acquires the learning data set X from the memory 15.

In step S121, the CPU 11 acquires a trained data set (for example, the trained data set A) from among the multiple trained data sets A to D stored in the memory 15.

In step S122, the CPU 11 calculates, for example, the degree of similarity between the input data Aᵢₙ acquired in step S121 and the input data Xᵢₙ of the learning data set X and the degree of similarity between the correct data Aₒᵤₜ acquired in step S121 and the correct data Xₒᵤₜ of the learning data set X, as illustrated in FIG. 7 above. When the degree of similarity is calculated for both of the input data and the correct data, the mean value of the pieces of data may be used for the degree of similarity to the trained data set A, or the total value of the pieces of data may be used for the degree of similarity to the trained data set A. In addition, only the degrees of similarity between the pieces of input data or only the degrees of similarity between the pieces of correct data may be used.

In step S123, the CPU 11 determines whether degrees of similarity have been calculated for all the trained data sets. If it is determined that degrees of similarity have been calculated for all the trained data sets (an affirmative determination), the processing proceeds to step S124. If it is determined that degrees of similarity have not been calculated for all the trained data sets (a negative determination), the processing returns to step S121 and repeats the steps. In this exemplary embodiment, steps S121 to S122 are repeatedly performed for each of the trained data set B, the trained data set C, and the trained data set D. Specifically, the degree of similarity between the input data Bᵢₙ and the input data Xᵢₙ and the degree of similarity between the correct data Bₒᵤₜ and the correct data Xₒᵤₜ are calculated for the trained data set B, the degree of similarity between the input data Cᵢₙ and the input data Xᵢₙ and the degree of similarity between the correct data Cₒᵤₜ and the correct data Xₒᵤₜ are calculated for the trained data set C, and the degree of similarity between the input data Dᵢₙ and the input data Xᵢₙ and the degree of similarity between the correct data Dₒᵤₜ and the correct data Xₒᵤₜ are calculated for the trained data set D.

In step S124, the CPU 11 selects a trained data set similar to the learning data set X from among the multiple trained data sets A to D having undergone the degree of similarity calculation by step S123. For example, if the mean value of the degrees of similarity is used for the degrees of similarity, the trained data set having the highest mean value may be selected. Alternatively, if the count of degrees of similarity exceeding the threshold is used for the degrees of similarity, the trained data set having the highest count may be selected.

In step S125, the CPU 11 decides learning data to be used for the machine learning for New Case X. Specifically, the trained data set selected in step S124 and the learning data set X of New Case X are decided as the learning data. In deciding the learning data, the above-described data augmentation may be performed to increase the number of pieces of data.

In step S126, the CPU 11 decides an initial value to be used for the machine learning for New Case X. As described above, for example, a value obtained from the trained data set selected in step S124 is decided as the initial value for the machine learning. At this time, a value obtained from the trained data set selected in step S124 may apply to a hyper parameter.

In step S127, the CPU 11 performs the machine learning for New Case X by using the learning data decided in step S125 and the initial value decided in step S126 and generates a learning model.

In step S128, the CPU 11 outputs the learning model generated in step S127 as the learning result and then terminates the series of steps performed by the learning program 15A.

According to this exemplary embodiment as described above, each degree of similarity is calculated by using corresponding pieces of data of the trained data sets. Accordingly, the degree of similarity between the learning data set of the new case and each trained data set is accurately calculated.

### Third Exemplary Embodiment

In a third exemplary embodiment, selecting a similar trained data set by using a learning model obtained by performing machine learning on multiple trained data sets will be described.

This exemplary embodiment has the same configuration as that of the learning device 10 described for the first exemplary embodiment above. Repeated explanation is omitted, and only a difference will be described with reference to FIG. 2 above.

FIG. 9 is a diagram for explaining a degree-of-similarity calculation method according to the third exemplary embodiment.

As illustrated in FIG. 9, the learning data set X includes the input data Xᵢₙ and the correct data Xₒᵤₜ. The trained data set A includes the input data Aᵢₙ and the correct data Aₒᵤₜ. Likewise, the trained data set B includes the input data Bᵢₙ and the correct data Bₒᵤₜ The trained data set C includes the input data Cᵢₙ and the correct data Cₒᵤₜ. The trained data set D includes the input data Dᵢₙ and the correct data Dₒᵤₜ.

The degree-of-similarity calculation unit 11B generates a learning model X by performing the machine learning by using the pieces of input data Aᵢₙ to Dᵢₙ and the pieces of correct data Aₒᵤₜ to Dₒᵤₜ included in the multiple respective trained data sets A to D. The selection unit 11C then inputs the input data Xᵢₙ and the correct data Xₒᵤₜ of the learning data set X to the learning model X generated by the degree-of-similarity calculation unit 11B. On the basis of an output result obtained by the generated learning model X (for example, Case A or Case B or Case C or Case D), the selection unit 11C selects a trained data set similar to the learning data set X.

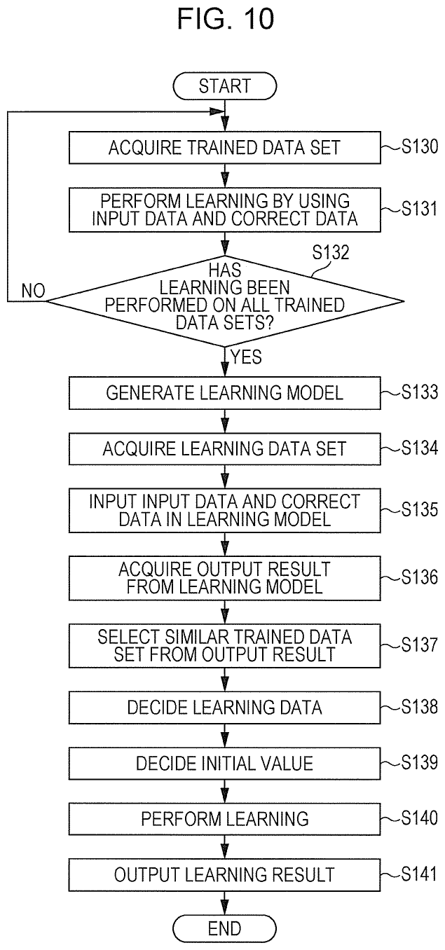

Actions of the learning device 10 according to the third exemplary embodiment will be described with reference to FIG. 10.

FIG. 10 is a flowchart illustrating an example of the flow of processing performed by a learning program 15A according to the third exemplary embodiment.

First, the learning device 10 is instructed to execute a machine learning process for New Case X, and then the CPU 11 starts the learning program 15A and performs the following steps.

In step S130 in FIG. 10, the CPU 11 acquires a trained data set (for example, the trained data set A) from among the multiple trained data sets A to D stored in the memory 15.

In step S131, the CPU 11 performs the machine learning by using, for example, the input data Aᵢₙ and the correct data Aₒᵤₜ of the trained data set A as illustrated in FIG. 9 above.

In step S132, the CPU 11 determines whether the machine learning has been performed on all the trained data sets. If it is determined that the machine learning has been performed on all the trained data sets (an affirmative determination), the processing proceeds to step S133. If it is determined that the machine learning has not been performed on all the trained data sets (a negative determination), the processing returns to step S130 and repeats the steps. In this exemplary embodiment, steps S130 and S131 are repeatedly performed for each of the trained data set B, the trained data set C, and the trained data set D. Specifically, the machine learning is performed by using the input data Bᵢₙ and the correct data Bₒᵤₜ of the trained data set B, the machine learning is performed by using the input data Cᵢₙ and the correct data Cₒᵤₜ of the trained data set C, and the machine learning is performed by using the input data Dᵢₙ and the correct data Dₒᵤₜ of the trained data set D.

In step S133, the CPU 11 generates the learning model X, for example, by performing the machine learning by step S132, as illustrated in FIG. 9 above. The learning model X is a classification model for classification into Cases A to D.

In step S134, the CPU 11 acquires the learning data set X from the memory 15.

In step S135, the CPU 11 inputs, for example, the input data Xᵢₙ and the correct data Xₒᵤₜ of the learning data set X acquired in step S134 to the learning model X generated in step S133, as illustrated in FIG. 9 above.

In step S136, the CPU 11 acquires, for example, the output result from the learning model X (for example, Case A or Case B or Case C or Case D), as illustrated in FIG. 9 above.

In step S137, the CPU 11 selects a similar trained data set from the output result acquired in step S136 (for example, Case A or Case B or Case C or Case D).

In step S138, the CPU 11 decides learning data to be used for the machine learning for New Case X. Specifically, the trained data set selected in step S137 and the learning data set X of New Case X are decided as learning data. In deciding the learning data, the above-described data augmentation may be performed to increase the number of pieces of data.

In step S139, the CPU 11 decides an initial value to be used for the machine learning for New Case X. As described above, for example, a value obtained from the trained data set selected in step S137 is decided as the initial value for the machine learning. At this time, a value obtained from the trained data set selected in step S137 may apply to a hyper parameter.

In step S140, the CPU 11 performs the machine learning for New Case X by using the learning data decided in step S138 and the initial value decided in step S139 and generates a learning model.

In step S141, the CPU 11 outputs the learning model generated in step S140 as the learning result and then terminates the series of steps performed by the learning program 15A.

According to this exemplary embodiment as described above, the similar trained data set is selected by using the learning model obtained by performing the machine learning on the multiple trained data sets. Accordingly, the trained data set similar to the learning data set of the new case is accurately selected.

### Fourth Exemplary Embodiment

For a fourth exemplary embodiment, a case where the input data and the correct data are respectively an image with a watermark and an image without a watermark will be described.

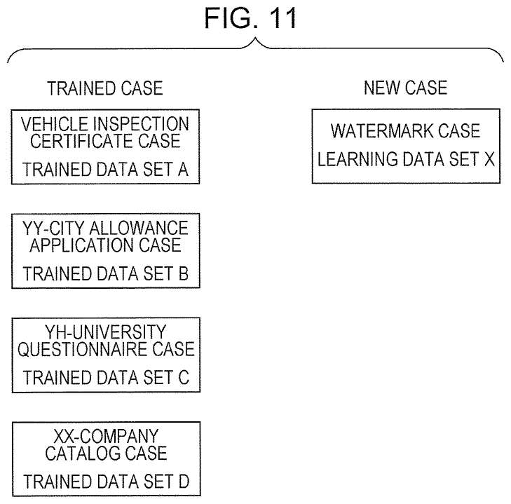

FIG. 11 is a diagram illustrating an example of trained cases and a new case according to the fourth exemplary embodiment.

As illustrated in FIG. 11, the multiple trained cases include a vehicle inspection certificate case, a YY-City allowance application case, a YH-University questionnaire case, and an XX-Company catalog case. The vehicle inspection certificate case has a trained data set A. The trained data set A includes an input image, a correct image, data regarding a difference between the input image and the correct image, and a trained model. The input image for the vehicle inspection certificate is an image with a watermark, and the correct image for the vehicle inspection certificate is an image without a watermark. The YY-City allowance application case has a trained data set B. The trained data set B includes an input image, a correct image, data regarding a difference between the input image and the correct image, and a trained model. The YH-University questionnaire case has a trained data set C. The trained data set C includes an input image, a correct image, data regarding a difference between the input image and the correct image, and a trained model. The XX-Company catalog case has a trained data set D. The trained data set D includes an input image, a correct image, data regarding a difference between the input image and the correct image, and a trained model.

In contrast, the watermark case that is a new case has a learning data set X including an input image, a correct image, and data regarding a difference between the input image and the correct image. The input image is an image with a watermark, and the correct image is an image without a watermark.

In the example in FIG. 11, the trained data set A of the vehicle inspection certificate case is selected as a trained data set similar to the learning data set X from among the multiple trained data sets A to D. Specifically, the trained case most similar to the learning data set X representing the presence and the absence of a watermark is determined as the trained data set A of the vehicle inspection certificate likewise representing the presence and the absence of a watermark. In this case, the machine learning for a new case is performed by using the trained model of the trained data set A with, for example, the input image and the correct image of the trained data set A and the input image and the correct image of the learning data set X serving as the learning data. Alternatively, the machine learning for a new case may be performed by using the trained model of the trained data set A with the input image and the correct image of the learning data set X serving as the learning data.

In the embodiments above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The learning device according to each exemplary embodiment has been illustrated and described. The exemplary embodiment may take the form of a program for causing a computer to implement the functions of the units of the learning device. The exemplary embodiment may also take the form of a non-transitory computer readable storage medium storing the program.

The configuration of the learning device described for each exemplary embodiment above is an example and may be modified in accordance with the circumstances without departing from the spirit of the exemplary embodiment.

The flow of the processing performed by the program described for the exemplary embodiment above is also an example. A deletion of an unnecessary step, an addition of a new step, and a change of the order of the steps may be performed without departing from the spirit of the exemplary embodiment.

The case where the program is run and thereby the processing according to the exemplary embodiment is implemented by using the computer and the software configuration therefore has heretofore been described for the exemplary embodiment above; however, the exemplary embodiment is not limited to this case. The exemplary embodiment may be implemented by, for example, a hardware configuration and combination of the hardware configuration and the software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A learning device comprising:
a processor configured to
select a trained data set from a plurality of trained data sets that are respectively used for machine learning for a plurality of past cases, the plurality of trained data sets each including input data, correct data, and a trained model, the selected trained data set being similar to a learning data set including input data and correct data to be used for machine learning for a new case and
perform machine learning by using the input data and the correct data of the selected trained data set and the input data and the correct data of the learning data set.

2. The learning device according to claim 1,
wherein the processor inputs the input data of the learning data set to the trained model of each of the plurality of trained data sets, calculates a degree of similarity between output data obtained from the trained model and the correct data of the learning data set, and selects the trained data set similar to the learning data set on a basis of the calculated degree of similarity.

3. The learning device according to claim 2,
wherein the degree of similarity is represented by at least one of a difference between a pixel value of the output data and a pixel value of the correct data of the learning data set, a recognition rate of the output data to the correct data of the learning data set, and an edit distance from the output data to the correct data of the learning data set.

4. The learning device according to claim 1,
wherein the processor calculates a degree of similarity to the learning data set for each of the plurality of trained data sets and selects the trained data set similar to the learning data set on a basis of the calculated degree of similarity.

5. The learning device according to claim 4,
wherein the degree of similarity is at least one of a degree of similarity between the input data of the trained data set and the input data of the learning data set and a degree of similarity between the correct data of the trained data set and the correct data of the learning data set.

6. The learning device according to claim 1,
wherein the processor generates a learning model by performing machine learning by using the input data and the correct data included in each of the plurality of trained data sets, inputs the input data and the correct data of the learning data set to the generated learning model, and selects the trained data set similar to the learning data set on a basis of an output result obtained from the generated learning model.

7. The learning device according to claim 1,
wherein the processor narrows down the plurality of trained data sets to one or more trained data sets processible by the learning device on a basis of information regarding an implementation target for the learning device.

8. The learning device according to claim 2,
wherein the processor narrows down the plurality of trained data sets to one or more trained data sets processible by the learning device on a basis of information regarding an implementation target for the learning device.

9. The learning device according to claim 3,
wherein the processor narrows down the plurality of trained data sets to one or more trained data sets processible by the learning device on a basis of information regarding an implementation target for the learning device.

10. The learning device according to claim 4,
wherein the processor narrows down the plurality of trained data sets to one or more trained data sets processible by the learning device on a basis of information regarding an implementation target for the learning device.

11. The learning device according to claim 5,
wherein the processor narrows down the plurality of trained data sets to one or more trained data sets processible by the learning device on a basis of information regarding an implementation target for the learning device.

12. The learning device according to claim 6,
wherein the processor narrows down the plurality of trained data sets to one or more trained data sets processible by the learning device on a basis of information regarding an implementation target for the learning device.

13. The learning device according to claim 1,
wherein when performing the machine learning for the new case, the processor sets, as an initial value for the machine learning, a value obtained from the selected trained data set.

14. The learning device according to claim 2,
wherein when performing the machine learning for the new case, the processor sets, as an initial value for the machine learning, a value obtained from the selected trained data set.

15. The learning device according to claim 3,
wherein when performing the machine learning for the new case, the processor sets, as an initial value for the machine learning, a value obtained from the selected trained data set.

16. The learning device according to claim 4,
wherein when performing the machine learning for the new case, the processor sets, as an initial value for the machine learning, a value obtained from the selected trained data set.

17. The learning device according to claim 5,
wherein when performing the machine learning for the new case, the processor sets, as an initial value for the machine learning, a value obtained from the selected trained data set.

18. The learning device according to claim 6,
wherein when performing the machine learning for the new case, the processor sets, as an initial value for the machine learning, a value obtained from the selected trained data set.

19. The learning device according to claim 1,
wherein the selected trained data set further includes deformed input data and deformed correct data, the deformed input data being obtained by deforming the input data of the selected trained data set, the deformed correct data being correct data for the deformed input data, and
wherein the processor performs the machine learning by using the input data, the correct data, the deformed input data, and the deformed correct data of the selected trained data set and the input data and the correct data of the learning data set.

20. A non-transitory computer readable medium storing a program causing a computer to execute a process for learning, the process comprising:
selecting a trained data set from a plurality of trained data sets that are respectively used for machine learning for a plurality of past cases, the plurality of trained data sets each including input data, correct data, and a trained model, the selected trained data set being similar to a learning data set including input data and correct data to be used for machine learning for a new case and
performing machine learning by using the input data and the correct data of the selected trained data set and the input data and the correct data of the learning data set.
